(19) United States
(12) Patent Application Publication
(10) Pub. No.: US 2026/0201233 A1
(43) Pub. Date: Jul. 16, 2026

(54) NANOFLUID FOR HVAC APPLICATIONS

(71) Applicant: HT MATERIALS SCIENCE (IP) LIMITED, DUBLIN 2 (IE)

(72) Inventors: CLAUDIO GRISONI, Roma (IT); PIERO NEGRO, Torchiarolo (IT); GITA SINGH, DUBLIN 1 (IE)

(73) Assignee: HT MATERIALS SCIENCE (IP) LIMITED, DUBLIN 2 (IE)

(21) Appl. No.: 19/449,743

(22) Filed: Jan. 15, 2026

Related U.S. Application Data
(60) Provisional application No. 63/745,936, filed on Jan. 16, 2025.

(51) Int. Cl. C09K 5/10

(52) U.S. Cl. CPC C09K 5/10

(57) ABSTRACT

A nanofluid includes a base fluid, mixed graphite and graphene additive precursors comprising graphite and graphene, an organic acid and an oxidizing agent. Systems and methods are disclosed.

### TECHNICAL FIELD

The present disclosure relates, in general, to heat transfer mixtures, and more particularly, to nanofluids having a low viscosity and high thermal conductivity for use in heating, ventilation and air conditioning (HVAC) applications, as well as processes/methods for making such nanofluids.

### BACKGROUND

For well over a century, micro-sized particles with high thermal conductivity have been used to increase the thermal characteristics of working fluids. However, micro-sized particles can be abrasive and can precipitate out due to their higher density. More recently, nano-sized particles were introduced into a base liquid to constitute a nanofluid. In particular, metal additives, such as, for example, copper, aluminum, or carbon have been used as nanoparticles to create colloidal suspension fluids with enhanced thermal characteristics versus mixtures that do not include such nanoparticles. Indeed, conventional nanofluids have shown varying degrees of improvement in thermal performance with the addition of the nanoparticles to the thermal fluid.

However, many conventional nanofluids require, among other things, one or more dispersants or surfactants, which create undue complexity and compromise long-term stability. Indeed, the addition of one or more dispersants or surfactants to a mixture introduces a new molecular component, with its own chemical properties, to the resulting nanofluid. Furthermore, many conventional nanofluids are only stable at a specific pH or a very narrow pH range (e.g., 8.0-9.0), which decreases the versatility of such nanofluids. Still further, many conventional nanofluids lack intrinsic self-lubricating properties that could reduce wear and friction in mechanical systems.

As such, a need currently exists for a commercially viable nanofluid that has a low viscosity and high thermal conductivity, does not require a dispersant or surfactant to ensure simplicity and long-term stability, is stable over a broad pH range to enhance versatility and includes intrinsic self-lubricating properties to reduce wear and friction in mechanical systems. This disclosure describes an improvement over these prior art technologies.

### SUMMARY

In one embodiment, in accordance with the principles of the present

disclosure, a nanofluid comprises: a base fluid; mixed graphite and graphene additive precursors comprising graphite and graphene; an organic acid; and an oxidizing agent.

In some embodiments, the mixed graphite and graphene additive precursors have a concentration in the nanofluid between about 1 g/L and about 10 g/L.

In some embodiments, the mixed graphite and graphene additive precursors have a concentration in the nanofluid between about 4 g/L and about 5 g/L.

In some embodiments, the mixed graphite and graphene additive precursors have a concentration in the nanofluid of about 2 g/L.

In some embodiments, the mixed graphite and graphene additive precursors have a concentration in the nanofluid between about 20 g/L and about 750 g/L.

In some embodiments, the mixed graphite and graphene additive precursors have a concentration in the nanofluid of about 50 g/L.

In some embodiments, the mixed graphite and graphene additive precursors have a concentration in the nanofluid of about 500 g/L.

In some embodiments, the nanofluid has a graphite to graphene ratio between about 1:99 and about 99:1.

In some embodiments, the nanofluid has a graphite to graphene ratio between about 2:98 and about 30:70.

In some embodiments, the nanofluid has a graphite to graphene ratio of about 20:80.

In some embodiments, the nanofluid has a graphite to graphene ratio of about 5:95.

In some embodiments, the nanofluid has a graphite to graphene ratio between about 10:90 and about 90:10.

In some embodiments, the nanofluid has a graphite to graphene ratio of about 10:90.

In some embodiments, the nanofluid has a graphite to graphene ratio of about 20:80.

In some embodiments, the nanofluid has a graphite to graphene ratio of about 30:70.

In some embodiments, the nanofluid has a graphite to graphene ratio of about 40:60.

In some embodiments, the nanofluid has a graphite to graphene ratio of about 50:50.

In some embodiments, the nanofluid has a graphite to graphene ratio of about 60:40.

In some embodiments, the nanofluid has a graphite to graphene ratio of about 70:30.

In some embodiments, the nanofluid has a graphite to graphene ratio of about 80:20.

In some embodiments, the nanofluid has a graphite to graphene ratio of about 90:10.

In some embodiments, the graphite is selected from the group consisting of flake graphite, amorphous graphite, synthetic graphite, electrographite, pyrolytic graphite, polycrystalline graphite, isostatic graphite, vein graphite, expanded graphite and combinations thereof.

In some embodiments, the graphite (herein synthetic graphite) is oxidized synthetic graphite. In some embodiments, the oxidized synthetic graphite is prepared by treating the synthetic graphite materials with inorganic acid/s (Phosphoric acid, Sulphuric acid, nitric acid, hydrochloric acid, Boric acid) under mechanical stirring for between about 1 hour and about 5 hours.

In some embodiments, the graphene is selected from the group consisting of monolayer graphene, multi-layer graphene, bilayer graphene, exfoliated graphene, Chemical vapor deposition (CVD) graphene, graphene sheets and combinations thereof.

In some embodiments, the graphene is expanded graphene powder. In some embodiments, the expanded graphene powder is produced by treating natural graphite flakes with acids (e.g., sulfuric, nitric) and oxidizing agents (e.g., hydrogen peroxide, potassium permanganate) at between about 30° C. to about 130° C. for up to 4 hours, followed by washing and drying.

In some embodiments, the organic acid is selected from the group consisting of Acetic acid (CH₃COOH), Oxalic acid (C₂H₂O₄), Citric acid (C₆H₈O₇) Lactic acid (C₃H₆O₃), Salicylic acid (C₇H₆O₃), tannic acid, Gallic Acid (C₇H₆O₅) and combinations thereof.

In some embodiments, the organic acid is tannic acid.

In some embodiments, the oxidizing agent is selected from the group consisting of Potassium permanganate (KMnO₄), Hydrogen peroxide (H₂O₂), Sodium dichromate (Na₂Cr₂O₇), Potassium dichromate (K₂Cr₂O₇), Benzoyl peroxide and combinations thereof.

In some embodiments, the oxidizing agent is hydrogen peroxide.

In some embodiments, the graphite has an average particle size between about 1 μm and 100 μm.

In some embodiments, the graphite has an average particle size between about 2 μm and about 14 μm.

In some embodiments, the graphite has an average particle size less than about 8 μm.

In some embodiments, the graphene has an average particle size between about 1 μm and 100 μm.

In some embodiments, the graphene has an average particle size of about D 90 55±3 μm.

In some embodiments, the nanofluid is free of dispersants.

In some embodiments, the nanofluid is free of surfactants.

In some embodiments, the base selected is selected from the group consisting of tap water, distilled water, heat transfer fluids, dielectric fluid, NOVEC™, FLUORINERT™, propylene glycol (PG), ethylene glycol (EG) and combinations thereof.

In some embodiments, the base fluid is water.

In one embodiment, in accordance with the principles of the present disclosure, a nanofluid comprises: a base fluid; mixed graphite and graphene additive precursors comprising graphite and graphene; an organic acid; and an oxidizing agent. The mixed graphite and graphene additive precursors have a concentration in the nanofluid between about 1 g/L and about 10 g/L. The nanofluid has a graphite to graphene ratio between about 10:90 and about 90:10. The base fluid is water. The graphite is oxidized synthetic graphite. The graphene is expanded graphene powder. The organic acid is tannic acid. The oxidizing agent is hydrogen peroxide. The graphite has an average particle size less than about 8 μm. The graphene has an average particle size of about D 90 55±3 μm. The nanofluid is free of dispersants and surfactants.

In one embodiment, in accordance with the principles of the present disclosure, a nanofluid comprises: a base fluid; mixed graphite and graphene additive precursors comprising graphite and graphene; an organic acid; and an oxidizing agent. The mixed graphite and graphene additive precursors have a concentration in the nanofluid between about 20 g/L and about 750 g/L. The nanofluid has a graphite to graphene ratio between about 2:98 and about 30:70. The base fluid is water. The graphite is oxidized synthetic graphite. The graphene is expanded graphene powder. The organic acid is tannic acid. The oxidizing agent is hydrogen peroxide. The graphite has an average particle size less than about 8 μm. The graphene has an average particle size of about D 90 55±3 μm. The nanofluid is free of dispersants and surfactants.

In one embodiment, in accordance with the principles of the present disclosure, a method of forming a nanofluid comprises: processing graphite to have a first selected particle size; processing graphene to have a second selected particle size; treating the processed graphite and the graphene with an inorganic acid and a first organic acid to produce mixed graphite and graphene additive precursors; adding a second organic acid to the mixed graphite and graphene additive precursors to produce a first combination; adding an oxidizing agent to the first combination to produce a second combination; diluting the second combination with a base fluid to produce the nanofluid.

In some embodiments, the method further comprises decomposing the mixed graphite and graphene additive precursors by subjecting the second composition to a selected temperature at a selected pressure.

In some embodiments, the selected temperature is between about 80° C. and about 180° C.

In some embodiments, the selected pressure is between about 950 mmHg and about 2,350 mmHg.

In some embodiments, the graphite and the graphene are treated with at least one of the inorganic acid and the first organic acid under constant stirring.

In some embodiments, at least one of the graphite and the graphene are treated with at least one of the inorganic acid and the first organic acid under sonication of about 50 W to about 150 W for hydrothermal treatment.

In some embodiments, processing the graphite comprises milling the graphite to have an average particle size between about 1 μm and about 100 μm.

In some embodiments, processing the graphite comprises milling the graphite to have an average particle size between about 2 μm and about 14 μm.

In some embodiments, processing the graphite comprises milling the graphite to have an average particle size less than about 8 μm.

In some embodiments, processing the graphene comprises milling the graphene to have an average particle size between about 1 μm and about 100 μm.

In some embodiments, processing the graphene comprises milling the graphene to have an average particle size of about D 90 55±3 μm.

In some embodiments, the second combination has a pH between about 5.0 and about 8.0.

In some embodiments, the mixed graphite and graphene additive precursors have a concentration in the nanofluid between about 1 g/L and about 10 g/L. The nanofluid has a graphite to graphene ratio between about 10:90 and about 90:10. The base fluid is water. The graphite is oxidized synthetic graphite. The graphene is expanded graphene powder. The organic acid is tannic acid. The oxidizing agent is hydrogen peroxide. The graphite has an average particle size less than about 8 μm. The graphene has an average particle size of about D 90 55±3 μm. The nanofluid is free of dispersants and surfactants.

In some embodiments, the mixed graphite and graphene additive precursors have a concentration in the nanofluid between about 20 g/L and about 750 g/L. The nanofluid has a graphite to graphene ratio between about 2:98 and about 30:70. The base fluid is water. The graphite is oxidized synthetic graphite. The graphene is expanded graphene powder. The organic acid is tannic acid. The oxidizing agent is hydrogen peroxide. The graphite has an average particle size less than about 8 μm. The graphene has an average particle size of about D 90 55±3 μm. The nanofluid is free of dispersants and surfactants.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific compositions, formulations, methods, conditions or parameters described and/or shown herein, and that the terminology used herein is for the purpose of describing particular embodiments by way of example only and is not intended to be limiting of the claimed disclosure. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Further, when such a range is expressed, it is understood that the present disclosure includes each and every integer within that range. For example, when a range of 1-10 is expressed, the range includes 1, 2, 3, 4, 5, 6, 7, 8, 9 and 10. Similarly, when values are expressed as approximations, by use of the antecedent “about,” it will be understood that the particular value forms another embodiment. For example, instances of “about 1” include “1”, instances of “about 2” include “2”, etc. The ranges disclosed herein can include any of the upper limits of the ranges in combination with any of the lower limits of the ranges. For example, instances of “about 1 to about 10” include “1” and “10”.

The following discussion includes a description of a heat transfer mixture, such as, for example, a nanofluid for HVAC applications, in accordance with the principles of the present disclosure. Alternate embodiments are also disclosed. Reference will now be made in detail to the exemplary embodiments of the present disclosure.

The present disclosure relates to compositions, formulations, processes and applications for a nanofluid for HVAC applications in which the nanofluid has low viscosity, high thermal conductivity, does not require a dispersant or surfactant to ensure simplicity and long-term stability, is stable over a broad pH range to enhance versatility and includes intrinsic self-lubricating properties to reduce wear and friction in mechanical systems (e.g., an HVAC system). In some embodiments, a solid phase of the nanofluid is dispersed in a liquid of the nanofluid. The solid phase is made of clusters that have a dimension such to avoid phonon scattering that might occur at the liquid solid interphase. The nanofluid of the present disclosure is formulated and processed, taking the above into account, to maximize the heat transfer capability of the nanofluid. In some embodiments, the nanofluid can be installed into a thermal system (e.g., an HVAC system) with a retrofit solution, which feeds the existing heat transfer fluid into the thermal system.

A nanofluid is a heterogeneous suspension or mixture comprising two phases, a solid phase and a liquid phase, in which the dimensions of the solid phase components in suspension are nanometric. The two phases of the suspension are also separable through mechanical methods, since the substances used to form the heterogeneous mixture or suspension do not modify their structure, as is the case, for example, in the solutions.

The presence of graphite and graphene nanoparticles gives the nanofluid relevant thermal and fluid dynamic properties compared to the base fluid. For example, the thermal conductivity, heat capacity, viscosity, density and electrical conductivity.

In many nanofluids known as the state of the art, the nanoparticles of the solid phase have a tendency to deposit due to gravity. This is a phenomenon that has several consequences because it causes a reduction of the volumetric concentration of the nanoparticles inside the nanofluid therefore the thermal and fluid properties are different than expected. Furthermore, in an unstable nanofluid the particles tend to accumulate inside the pipes where the nanofluid is installed leading to clogging thus creating an obvious problem for certain applications.

Another phenomenon observed in the nanofluids known as the state of the art is the tendency of the nanopowders to generate clusters or agglomerations (solids composed by the combination of various nanometric particles) which have substantially larger dimensions of the individual particles. This phenomenon is negative, as it modifies the properties of the nanofluid, increases the tendency to settle and significantly increases the abrasion of the fluid which can lead to failures in certain components of the system.

The nanofluid of the present disclosure has a greater heat exchange capacity because it has a high thermal conductivity, a higher density and thermal capacity and provides a stable nanofluid, in which the solid phase does not tend to separate from the liquid phase or deposit on the pipe surface inside the system.

A particle dispersed in a liquid generally presents at the surface the electrostatic charges that generate an electric field responsible for the redistribution of the ions present around the surface of the nanoparticles. This leads to an increase in the concentration of ions with electrical charge opposite to those on the particle surface.

This electrical charge distribution causes a variable electrical potential with the distance from the particle, called zeta potential. When two particles are so close together that their double layers overlap, they repel each other with an electrostatic force whose intensity depends on the potential zeta, and at the same time attract each other for the well-known attraction of Van der Walls. If the zeta potential is too low, the repulsive force is not strong enough to overcome the Van der Walls attraction between the particles, and the particles will start to agglomerate making the suspension unstable. Conventional nanofluids add a dispersant and/or a surfactant to a water-based suspension to create a high zeta potential that prevents agglomeration and maintains uniform dispersion. The dispersant and/or surfactant molecules intervene on the separation surfaces between the liquid phase and the solid phase with the polar part facing the liquid phase and the polar part towards the solid phase. However, the dispersant(s) and/or surfactant(s) introduce a new molecular component to the other components of the nanofluid, thus causing undue complexity and compromising long-term stability. Accordingly, the nanofluid of the present disclosure is free of dispersants and/or surfactants. That is, the nanofluid of the present disclosure does not include any dispersants and/or surfactants.

In some embodiments, the nanofluid of the present disclosure is an engineered suspension of nanometer-sized solid particles in a base fluid. Suspending small solid particles in the energy transmission fluids can improve their thermal conductivity and provides an effective and innovative way to significantly enhance their heat transfer characteristics by increasing convective heat transfer in closed loop hydronic systems, reducing energy demand. The nanofluid of the present disclosure can be applied to various industrial and commercial HVAC systems and related components including chillers, heat exchangers, boilers and energy recovery units. Heat exchangers are sized for certain approach temperatures. The lower the approach operational temperature, the larger the heat exchanger. In fact, the specific surface of heat exchangers depends on the temperature difference between the two thermal fluids. The surface area of heat exchangers that is needed for exchanging an amount of heat in time depends also on the fluids involved and on the material properties of the exchanger surface that is subject to degradation over time. Because the nanofluid of the present disclosure leads the system fluid to higher thermal conductivity and mass flow rate, it increases heat transfer between the air and the thermal fluid, thereby increasing heat exchanger performance.

### Example 1—Producing a First Nanofluid

In some embodiments, a nanofluid of the present disclosure, such as, for example a first nanofluid is a graphite/graphene-based nanofluid for HVAC applications and is prepared by (1) adding mixed graphite and graphene additive precursors, (2) adding a selected amount of one or more organic acids, (3) adding a selected amount of an oxidizing agent, (4) decomposing the precursor materials by subjecting the reaction mixture to a selected temperature at a selected pressure for a selected amount of time, and (5) separating the hybrid materials. In some embodiments, the hybrid material refers to the combination of graphite and graphene. Separation involves isolating the functionalized product from reaction by-products, achieved by washing the suspension and filtering it until the desired pH is reached. As would be appreciated by one of ordinary skill in the art, the purpose of decomposing the precursor materials is to activate them and enable the functionalization mechanism.

In some embodiments, the method of producing the first nanofluid further comprises of treating the graphite and/or graphene with inorganic acid/s under continuous stirring. In some embodiments, the method of producing the first nanofluid further comprises treating graphite and/or graphene with organic acid under sonication for hydrothermal treatment. In some embodiments, the method of producing the first nanofluid further comprises treating graphite and/or graphene material to mechanical milling process. In some embodiments, the method of producing the first nanofluid further comprises adding the hybrid materials to a base fluid to produce the first nanofluid.

In some embodiments, the selected amount of the one or more organic acids used in the method of producing the first nanofluid is between about 10 mmol and about 50 mmol of the one or more organic acids. In some embodiments, the selected amount of the one or more organic acids used in the method of producing the first nanofluid is between about 20 mmol and about 40 mmol of the one or more organic acids. In some embodiments, the selected amount of the one or more organic acids used in the method of producing the first nanofluid is less than about 40 mmol of the one or more organic acids. In some embodiments, the selected amount of the one or more organic acids used in the method of producing the first nanofluid is less than about 39 mmol of the one or more organic acids. In some embodiments, the selected amount of the one or more organic acids used in the method of producing the first nanofluid is less than about 38 mmol of the one or more organic acids. In some embodiments, the selected amount of the one or more organic acids used in the method of producing the first nanofluid is less than about 37 mmol of the one or more organic acids. In some embodiments, the selected amount of the one or more organic acids used in the method of producing the first nanofluid is less than about 36 mmol of the one or more organic acids. In some embodiments, the selected amount of the one or more organic acids used in the method of producing the first nanofluid is less than about 35 mmol of the one or more organic acids. In some embodiments, the selected amount of the one or more organic acids used in the method of producing the first nanofluid is less than about 34 mmol of the one or more organic acids. In some embodiments, the selected amount of the one or more organic acids used in the method of producing the first nanofluid is less than about 33 mmol of the one or more organic acids. In some embodiments, the selected amount of the one or more organic acids used in the method of producing the first nanofluid is less than about 32 mmol of the one or more organic acids. In some embodiments, the selected amount of the one or more organic acids used in the method of producing the first nanofluid is less than about 31 mmol of the one or more organic acids. In some embodiments, the selected amount of the one or more organic acids used in the method of producing the first nanofluid is about 30 mmol of the one or more organic acids. In some embodiments, the selected amount of the one or more organic acids used in the method of producing the first nanofluid is less than about 30 mmol of the one or more organic acids.

In some embodiments, the selected amount of the oxidizing agent used in the method of producing the first nanofluid is between about 0.01 mL and about 20 mL of a 5-65% oxidizing agent. In some embodiments, the selected amount of the oxidizing agent used in the method of producing the first nanofluid is between about 0.1 mL and about 15 mL of a 10-50% oxidizing agent. In some embodiments, the selected amount of the oxidizing agent used in the method of producing the first nanofluid is between about 1ml and about 10ml of of a 35% oxidizing agent. In some embodiments, the selected amount of the oxidizing agent used in the method of producing the first nanofluid is less than about 15 mL of a 10-50% oxidizing agent. In some embodiments, the selected amount of the oxidizing agent used in the method of producing the first nanofluid is less than about 14 mL of a 10-50% oxidizing agent. In some embodiments, the selected amount of the oxidizing agent used in the method of producing the first nanofluid is less than about 13 mL of a 10-50% oxidizing agent. In some embodiments, the selected amount of the oxidizing agent used in the method of producing the first nanofluid is less than about 12 mL of a 10-50% oxidizing agent. In some embodiments, the selected amount of the oxidizing agent used in the method of producing the first nanofluid is less than about 11 mL of a 10-50% oxidizing agent. In some embodiments, the selected amount of the oxidizing agent used in the method of producing the first nanofluid is less than about 10 mL of a 10-50% oxidizing agent. In some embodiments, the selected amount of the oxidizing agent used in the method of producing the first nanofluid is less than about 9 mL of a 10-50% oxidizing agent. In some embodiments, the selected amount of the oxidizing agent used in the method of producing the first nanofluid is less than about 8 mL of a 10-50% oxidizing agent. In some embodiments, the selected amount of the oxidizing agent used in the method of producing the first nanofluid is less than about 7 mL of a 10-50% oxidizing agent. In some embodiments, the selected amount of the oxidizing agent used in the method of producing the first nanofluid is less than about 6 mL of a 10-50% oxidizing agent. In some embodiments, the selected amount of the oxidizing agent used in the method of producing the first nanofluid is less than about 5 mL of a 10-50% oxidizing agent. In some embodiments, the selected amount of the oxidizing agent used in the method of producing the first nanofluid is less than about 4 mL of a 10-50% oxidizing agent. In some embodiments, the selected amount of the oxidizing agent used in the method of producing the first nanofluid is less than about 3 mL of a 10-50% oxidizing agent. In some embodiments, the selected amount of the oxidizing agent used in the method of producing the first nanofluid is less than about 2 mL of a 10-50% oxidizing agent. In some embodiments, the selected amount of the oxidizing agent used in the method of producing the first nanofluid is less than about 1 mL of a 10-50% oxidizing agent.

In some embodiments, the selected temperature used in the method of producing the first nanofluid is between about 40° C. and about 220° C. In some embodiments, the selected temperature used in the method of producing the first nanofluid is between about 60° C. and about 200° C. In some embodiments, the selected temperature used in the method of producing the first nanofluid is between about 80° C. and about 180° C. In some embodiments, the selected temperature used in the method of producing the first nanofluid is less than about 200° C. In some embodiments, the selected temperature used in the method of producing the first nanofluid is less than about 180° C. In some embodiments, the selected temperature used in the method of producing the first nanofluid is less than about 160° C. In some embodiments, the selected temperature used in the method of producing the first nanofluid is less than about 140° C. In some embodiments, the selected temperature used in the method of producing the first nanofluid is less than about 120° C. In some embodiments, the selected temperature is less than about 100° C. In some embodiments, the selected temperature used in the method of producing the first nanofluid is less than about 80° C. In some embodiments, the selected temperature used in the method of producing the first nanofluid is less than about 60° C. In some embodiments, the selected temperature used in the method of producing the first nanofluid is greater than about 60° C. In some embodiments, the selected temperature is greater than about 80° C. In some embodiments, the selected temperature used in the method of producing the first nanofluid is greater than about 100° C. In some embodiments, the selected temperature used in the method of producing the first nanofluid is greater than about 120° C. In some embodiments, the selected temperature used in the method of producing the first nanofluid is greater than about 140° C. In some embodiments, the selected temperature used in the method of producing the first nanofluid is greater than about 160° C. In some embodiments, the selected temperature used in the method of producing the first nanofluid is greater than about 180° C. In some embodiments, the selected temperature used in the method of producing the first nanofluid is greater than about 200° C.

In some embodiments, the selected pressure used in the method of producing the first nanofluid is between about 500 mmHg and 3,000 mmHg. In some embodiments, the selected pressure used in the method of producing the first nanofluid is between about 750 mmHg and 2,500 mmHg. In some embodiments, the selected pressure used in the method of producing the first nanofluid is between about 950 mmHg and 2,350 mmHg. In some embodiments, the selected pressure used in the method of producing the first nanofluid is greater than about 500 mmHg. In some embodiments, the selected pressure is greater than about 750 mmHg. In some embodiments, the selected pressure used in the method of producing the first nanofluid is greater than about 1,000 mmHg. In some embodiments, the selected pressure used in the method of producing the first nanofluid is greater than about 1,250 mmHg. In some embodiments, the selected pressure is greater than about 1,500 mmHg. In some embodiments, the selected pressure used in the method of producing the first nanofluid is greater than about 1,750 mmHg. In some embodiments, the selected pressure used in the method of producing the first nanofluid is greater than about 2,000 mmHg. In some embodiments, the selected pressure used in the method of producing the first nanofluid is greater than about 2,250 mmHg. In some embodiments, the selected pressure used in the method of producing the first nanofluid is greater than about 2,500 mmHg. In some embodiments, the selected pressure used in the method of producing the first nanofluid is greater than about 2,750 mmHg. In some embodiments, the selected pressure used in the method of producing the first nanofluid is greater than about 3,000 mmHg.

In some embodiments, the selected amount of time used in the method of producing the first nanofluid is between about 0.1 hours and 12 hours. In some embodiments, the selected amount of time used in the method of producing the first nanofluid is between about 0.5 hours and 9 hours. In some embodiments, the selected amount of time used in the method of producing the first nanofluid is between about 1.0 hour and 6 hours. In some embodiments, the selected amount of time used in the method of producing the first nanofluid is greater than about 1.0 hour. In some embodiments, the selected amount of time used in the method of producing the first nanofluid is greater than about 2.0 hours. In some embodiments, the selected amount of time used in the method of producing the first nanofluid is greater than about 2.0 hours. In some embodiments, the selected amount of time used in the method of producing the first nanofluid is greater than about 2.0 hours. In some embodiments, the selected amount of time used in the method of producing the first nanofluid is greater than about 3.0 hours. In some embodiments, the selected amount of time used in the method of producing the first nanofluid is greater than about 4.0 hours. In some embodiments, the selected amount of time used in the method of producing the first nanofluid is greater than about 5.0 hours. In some embodiments, the selected amount of time used in the method of producing the first nanofluid is greater than about 6.0 hours. In some embodiments, the selected amount of time used in the method of producing the first nanofluid is greater than about 7.0 hours. In some embodiments, the selected amount of time used in the method of producing the first nanofluid is greater than about 8.0 hours. In some embodiments, the selected amount of time used in the method of producing the first nanofluid is greater than about 9.0 hours. In some embodiments, the selected amount of time used in the method of producing the first nanofluid is greater than about 10.0 hours. In some embodiments, the selected amount of time used in the method of producing the first nanofluid is greater than about 11.0 hours. In some embodiments, the selected amount of time used in the method of producing the first nanofluid is greater than about 12.0 hours. In some embodiments, the selected amount of time used in the method of producing the first nanofluid is greater than about 12.0 hours. In some embodiments, the selected amount of time used in the method of producing the first nanofluid is greater than about 11.0 hours. In some embodiments, the selected amount of time is less than about 10.0 hours. In some embodiments, the selected amount of time is less than about 9.0 hours. In some embodiments, the selected amount of time is less than about 8.0 hours. In some embodiments, the selected amount of time used in the method of producing the first nanofluid is less than about 7.0 hours. In some embodiments, the selected amount of time used in the method of producing the first nanofluid is less than about 6.0 hours. In some embodiments, the selected amount of time used in the method of producing the first nanofluid is less than about 5.0 hours. In some embodiments, the selected amount of time used in the method of producing the first nanofluid is less than about 4.0 hours. In some embodiments, the selected amount of time used in the method of producing the first nanofluid is less than about 3.0 hours. In some embodiments, the selected amount of time used in the method of producing the first nanofluid is less than about 2.0 hours. In some embodiments, the selected amount of time used in the method of producing the first nanofluid is less than about 1.0 hour.

In some embodiments, the graphite (e.g., expanded graphite) is sonicated with the organic acid in the method of producing the first nanofluid under sonication between about 10 W to about 300 W. As would be appreciated by one of ordinary skill in the art, the purpose of sonication is to disperse and disagglomerate the graphite within the aqueous solution. In some embodiments, the graphite and graphene are sonicated with the organic acid in the method of producing the first nanofluid under sonication between about 25 W to about 250 W. In some embodiments, the graphite and graphene are sonicated with the organic acid in the method of producing the first nanofluid under sonication between about 20 W to about 200 W. In some embodiments, the graphite and graphene are sonicated with the organic acid in the method of producing the first nanofluid under sonication between about 15 W to about 150 W.

In some embodiments, the base fluid used in the method of producing the first nanofluid is selected from the group consisting of tap water, distilled water, heat transfer fluids, dielectric fluid, NOVEC™, FLUORINERT™, propylene glycol (PG), ethylene glycol (EG), non-toxic EG, and combinations thereof. In some embodiments, the base fluid is water. In some embodiments, the graphite used in the method of producing the first nanofluid is selected from the group consisting of flake graphite, amorphous graphite, synthetic graphite, electrographite, pyrolytic graphite, polycrystalline graphite, isostatic graphite, vein graphite, expanded graphite and combinations thereof. In some embodiments, the graphite used in the method of producing the first nanofluid is oxidized synthetic graphite.

In some embodiments, the graphene used in the method of producing the first nanofluid is selected from the group consisting of monolayer graphene, multi-layer graphene, bi-layer graphene, exfoliated graphene, CVD graphene, graphene sheets and combinations thereof. In some embodiments, the graphene used in the method of producing the first nanofluid is expanded graphene powder.

In some embodiments, the organic acid used in the method of producing the first nanofluid is selected from the group consisting of Acetic acid (CH₃COOH), Oxalic acid (C₂H₂O₄), Citric acid (C₆H₈O₇), Lactic acid (C₃H₆O₃), Salicylic acid (C₇H₆O₃), tannic acid, Gallic Acid (C₇H₆O₅) and combinations thereof. In some embodiments, the organic acid is tannic acid.

In some embodiments, the oxidizing agent used in the method of producing the first nanofluid is selected from the group consisting of Potassium permanganate (KMnO₄), Hydrogen peroxide (H₂O₂), Sodium dichromate (Na₂Cr₂O₇), Potassium dichromate (K₂Cr₂O₇), Benzoyl peroxide and combinations thereof. In some embodiments, the oxidizing agent is Hydrogen peroxide.

In some embodiments, the the first nanofluid is free of any dispersants and/or surfactants.

### Example 2—Producing a Second Nanofluid

In some embodiments, a second nanofluid of the present disclosure is a graphite/graphene-based nanofluid for HVAC applications and is prepared in a three-step synthesis. Firstly, graphite and graphene materials undergo a milling process to produce graphite and graphene with a selected average particle size. In a second step of producing the second nanofluid, the graphite and graphene are treated with a selected amount of an inorganic acid under mechanical stirring. The final step of producing the second nanofluid is treating the graphite and graphene with a selected amount of an organic acid under sonication. To this, a selected amount of an oxidizing agent is added. The mixture is decomposed by subjecting the reaction mixture to a selected temperature, at a selected pressure, and for a selected amount of time. This decomposed mixture is separated and rinsed until a selected pH is achieved and the final concentration of the solid content in the second nanofluid is within a selected range.

In some embodiments, the selected average particle size of the graphite and graphene used in the method of producing the second nanofluid is between about 1 micron and about 200 microns. In some embodiments, the selected average particle size of the graphite and graphene used in the method of producing the second nanofluid is between about 1 micron and about 175 microns. In some embodiments, the selected average particle size of the graphite and graphene used in the method of producing the second nanofluid is between about 1 micron and about 150 microns. In some embodiments, the selected average particle size of the graphite and graphene used in the method of producing the second nanofluid is between about 1 micron and about 125 microns. In some embodiments, the selected average particle size of the graphite and graphene used in the method of producing the second nanofluid is between about 1 micron and about 100 microns. In some embodiments, the selected average particle size of the graphite and graphene used in the method of producing the second nanofluid is between about 1 micron and about 80 microns. In some embodiments, the selected average particle size of the graphite and graphene used in the method of producing the second nanofluid is between about 1 micron and about 60 microns. In some embodiments, the selected average particle size of the graphite and graphene used in the method of producing the second nanofluid is between about 1 micron and about 40 microns. In some embodiments, the selected average particle size of the graphite and graphene used in the method of producing the second nanofluid is between about 1 micron and about 20 microns. In some embodiments, the selected average particle size of the graphite and graphene used in the method of producing the second nanofluid is between about 1 micron and about 10 microns. In some embodiments, the selected average particle size of the graphite and graphene used in the method of producing the second nanofluid is greater than about 1 micron. In some embodiments, the selected average particle size of the graphite and graphene is greater than about 10 microns. In some embodiments, the selected average particle size of the graphite and graphene used in the method of producing the second nanofluid is greater than about 20 microns. In some embodiments, the selected average particle size of the graphite and graphene is greater than about 40 microns. In some embodiments, the selected average particle size of the graphite and graphene is greater than about 60 microns. In some embodiments, the selected average particle size of the graphite and graphene is greater than about 80 microns. In some embodiments, the selected average particle size of the graphite and graphene used in the method of producing the second nanofluid is greater than about 100 microns. In some embodiments, the selected average particle size of the graphite and graphene used in the method of producing the second nanofluid is greater than about 120 microns. In some embodiments, the selected average particle size of the graphite and graphene used in the method of producing the second nanofluid is less than about 120 microns. In some embodiments, the selected average particle size of the graphite and graphene used in the method of producing the second nanofluid is less than about 100 microns. In some embodiments, the selected average particle size of the graphite and graphene used in the method of producing the second nanofluid is less than about 80 microns. In some embodiments, the selected average particle size of the graphite and graphene used in the method of producing the second nanofluid is less than about 60 microns. In some embodiments, the selected average particle size of the graphite and graphene used in the method of producing the second nanofluid is less than about 40 microns. In some embodiments, the selected average particle size of the graphite and graphene used in the method of producing the second nanofluid is less than about 20 microns. In some embodiments, the selected average particle size of the graphite and graphene used in the method of producing the second nanofluid is less than about 10 microns. In some embodiments, the selected average particle size of the graphite and graphene used in the method of producing the second nanofluid is less than about 1 micron.

In some embodiments, the selected amount of the inorganic acid used in the method of producing the second nanofluid is between about 0.01 N and about 0.5 N. In some embodiments, the selected amount of the inorganic acid used in the method of producing the second nanofluid is between about 0.02 N and about 0.4 N. In some embodiments, the selected amount of the inorganic acid is between about 0.03 N and about 0.3 N. In some embodiments, the selected amount of the inorganic acid used in the method of producing the second nanofluid is between about 0.05 N and about 0.2 N. In some embodiments, the selected amount of the inorganic acid used in the method of producing the second nanofluid is greater than about 0.01 N. In some embodiments, the selected amount of the inorganic acid used in the method of producing the second nanofluid is greater than about 0.05 N. In some embodiments, the selected amount of the inorganic acid used in the method of producing the second nanofluid is greater than about 0.06 N. In some embodiments, the selected amount of the inorganic acid used in the method of producing the second nanofluid is greater than about 0.07 N. In some embodiments, the selected amount of the inorganic acid used in the method of producing the second nanofluid is greater than about 0.08 N. In some embodiments, the selected amount of the inorganic acid used in the method of producing the second nanofluid is greater than about 0.09 N. In some embodiments, the selected amount of the inorganic acid used in the method of producing the second nanofluid is greater than about 0.1 N. In some embodiments, the selected amount of the inorganic acid is greater than about 0.11 N. In some embodiments, the selected amount of the inorganic acid used in the method of producing the second nanofluid is greater than about 0.12 N. In some embodiments, the selected amount of the inorganic acid used in the method of producing the second nanofluid is greater than about 0.13 N. In some embodiments, the selected amount of the inorganic acid used in the method of producing the second nanofluid is greater than about 0.14 N. In some embodiments, the selected amount of the inorganic acid used in the method of producing the second nanofluid is greater than about 0.15 N. In some embodiments, the selected amount of the inorganic acid used in the method of producing the second nanofluid is greater than about 0.16 N. In some embodiments, the selected amount of the inorganic acid used in the method of producing the second nanofluid is greater than about 0.17 N. In some embodiments, the selected amount of the inorganic acid used in the method of producing the second nanofluid is greater than about 0.18 N. In some embodiments, the selected amount of the inorganic acid used in the method of producing the second nanofluid is greater than about 0.19 N. In some embodiments, the selected amount of the inorganic acid used in the method of producing the second nanofluid is greater than about 0.2 N.

In some embodiments, the graphite and graphene are stirred with the inorganic acid in the method of producing the second nanofluid for between about 0.5 hours and about 10 hours. In some embodiments, the graphite and graphene are stirred with the inorganic acid in the method of producing the second nanofluid for between about 0.5 hours and about 9 hours. In some embodiments, the graphite and graphene are stirred with the inorganic acid in the method of producing the second nanofluid for between about 0.5 hours and about 8 hours. In some embodiments, the graphite and graphene are stirred with the inorganic acid in the method of producing the second nanofluid for between about 0.5 hours and about 7 hours. In some embodiments, the graphite and graphene are stirred with the inorganic acid in the method of producing the second nanofluid for between about 0.5 hours and about 6 hours. In some embodiments, the graphite and graphene are stirred with the inorganic acid in the method of producing the second nanofluid for between about 1.0 hour and about 6 hours.

In some embodiments, the selected amount of the organic acid used in the method of producing the second nanofluid is between about 10 mmol and about 500 mmol of the organic acid. In some embodiments, the selected amount of the organic acid used in the method of producing the second nanofluid is between about 20 mmol and about 400 mmol of the organic acid. In some embodiments, the selected amount of the organic acid used in the method of producing the second nanofluid is between about 30 mmol and about 300 mmol of the organic acid. In some embodiments, the selected amount of the organic acid used in the method of producing the second nanofluid is less than about 500 mmol. In some embodiments, the selected amount of the organic acid used in the method of producing the second nanofluid is less than about 400 mmol. In some embodiments, the selected amount of the organic acid used in the method of producing the second nanofluid is less than about 300 mmol. In some embodiments, the selected amount of the organic acid used in the method of producing the second nanofluid is less than about 200 mmol. In some embodiments, the selected amount of the organic acid used in the method of producing the second nanofluid is less than about 100 mmol. In some embodiments, the selected amount of the organic acid used in the method of producing the second nanofluid is less than about 50 mmol. In some embodiments, the selected amount of the organic acid used in the method of producing the second nanofluid is less than about 20 mmol. In some embodiments, the selected amount of the organic acid used in the method of producing the second nanofluid is less than about 10 mmol. In some embodiments, the selected amount of the organic acid used in the method of producing the second nanofluid is greater than about 10 mmol. In some embodiments, the selected amount of the organic acid used in the method of producing the second nanofluid is greater than about 20 mmol. In some embodiments, the selected amount of the organic acid used in the method of producing the second nanofluid is greater than about 50 mmol. In some embodiments, the selected amount of the organic acid used in the method of producing the second nanofluid is greater than about 100 mmol. In some embodiments, the selected amount of the organic acid used in the method of producing the second nanofluid is greater than about 200 mmol. In some embodiments, the selected amount of the organic acid used in the method of producing the second nanofluid is greater than about 300 mmol. In some embodiments, the selected amount of the organic acid used in the method of producing the second nanofluid is greater than about 400 mmol. In some embodiments, the selected amount of the organic acid used in the method of producing the second nanofluid is greater than about 500 mmol.

In some embodiments, the graphite and graphene are sonicated with the organic acid in the method of producing the second nanofluid under sonication between about 10 W to about 300 W. In some embodiments, the graphite and graphene are sonicated with the organic acid in the method of producing the second nanofluid under sonication between about 25 W to about 250 W. In some embodiments, the graphite and graphene are sonicated with the organic acid in the method of producing the second nanofluid under sonication between about 20 W to about 200 W. In some embodiments, the graphite and graphene are sonicated with the organic acid in the method of producing the second nanofluid under sonication between about 15 W to about 150 W.

In some embodiments, the selected amount of the oxidizing agent used in the method of producing the second nanofluid is between about 0.01 mL and about 20 mL of a 2-65% oxidizing agent. In some embodiments, the selected amount of the oxidizing agent used in the method of producing the second nanofluid is between about 0.1 mL and about 15 mL of a 3-50% oxidizing agent. In some embodiments, the selected amount of the oxidizing agent used in the method of producing the second nanofluid is between about 1 ml and about 10 ml of of a 5-35% oxidizing agent. In some embodiments, the selected amount of the oxidizing agent used in the method of producing the second nanofluid is less than about 15 mL of a 10-50% oxidizing agent. In some embodiments, the selected amount of the oxidizing agent used in the method of producing the second nanofluid is less than about 14 mL of a 10-50% oxidizing agent. In some embodiments, the selected amount of the oxidizing agent used in the method of producing the second nanofluid is less than about 13 mL of a 10-50% oxidizing agent. In some embodiments, the selected amount of the oxidizing agent used in the method of producing the second nanofluid is less than about 12 mL of a 10-50% oxidizing agent. In some embodiments, the selected amount of the oxidizing agent used in the method of producing the second nanofluid is less than about 11 mL of a 10-50% oxidizing agent. In some embodiments, the selected amount of the oxidizing agent used in the method of producing the second nanofluid is less than about 10 mL of a 10-50% oxidizing agent. In some embodiments, the selected amount of the oxidizing agent used in the method of producing the second nanofluid is less than about 9 mL of a 10-50% oxidizing agent. In some embodiments, the selected amount of the oxidizing agent used in the method of producing the second nanofluid is less than about 8 mL of a 10-50% oxidizing agent. In some embodiments, the selected amount of the oxidizing agent used in the method of producing the second nanofluid is less than about 7 mL of a 10-50% oxidizing agent. In some embodiments, the selected amount of the oxidizing agent used in the method of producing the second nanofluid is less than about 6 mL of a 10-50% oxidizing agent. In some embodiments, the selected amount of the oxidizing agent used in the method of producing the second nanofluid is less than about 5 mL of a 10-50% oxidizing agent. In some embodiments, the selected amount of the oxidizing agent used in the method of producing the second nanofluid is less than about 4 mL of a 10-50% oxidizing agent. In some embodiments, the selected amount of the oxidizing agent used in the method of producing the second nanofluid is less than about 3 mL of a 10-50% oxidizing agent. In some embodiments, the selected amount of the oxidizing agent used in the method of producing the second nanofluid is less than about 2 mL of a 10-50% oxidizing agent. In some embodiments, the selected amount of the oxidizing agent used in the method of producing the second nanofluid is less than about 1 mL of a 10-50% oxidizing agent.

In some embodiments, the selected temperature used in the method of producing the second nanofluid is between about 40° C. and about 220° C. In some embodiments, the selected temperature used in the method of producing the second nanofluid is between about 60° C. and about 200° C. In some embodiments, the selected temperature used in the method of producing the second nanofluid is between about 80° C. and about 180° C. In some embodiments, the selected temperature used in the method of producing the second nanofluid is less than about 200° C. In some embodiments, the selected temperature used in the method of producing the second nanofluid is less than about 180° C. In some embodiments, the selected temperature used in the method of producing the second nanofluid is less than about 160° C. In some embodiments, the selected temperature used in the method of producing the second nanofluid is less than about 140° C. In some embodiments, the selected temperature used in the method of producing the second nanofluid is less than about 120° C. In some embodiments, the selected temperature used in the method of producing the second nanofluid is less than about 100° C. In some embodiments, the selected temperature used in the method of producing the second nanofluid is less than about 80° C. In some embodiments, the selected temperature used in the method of producing the second nanofluid is less than about 60° C. In some embodiments, the selected temperature used in the method of producing the second nanofluid is greater than about 60° C. In some embodiments, the selected temperature used in the method of producing the second nanofluid is greater than about 80° C. In some embodiments, the selected temperature used in the method of producing the first nanofluid is greater than about 100° C. In some embodiments, the selected temperature used in the method of producing the second nanofluid is greater than about 120° C. In some embodiments, the selected temperature used in the method of producing the second nanofluid is greater than about 140° C. In some embodiments, the selected temperature used in the method of producing the second nanofluid is greater than about 160° C. In some embodiments, the selected temperature used in the method of producing the second nanofluid is greater than about 180° C. In some embodiments, the selected temperature used in the method of producing the second nanofluid is greater than about 200° C.

In some embodiments, the selected pressure used in the method of producing the second nanofluid is between about 500 mmHg and 3,000 mmHg. In some embodiments, the selected pressure used in the method of producing the second nanofluid is between about 750 mmHg and 2,500 mmHg. In some embodiments, the selected pressure used in the method of producing the second nanofluid is between about 950 mmHg and 2,350 mmHg. In some embodiments, the selected pressure used in the method of producing the second nanofluid is greater than about 500 mmHg. In some embodiments, the selected pressure used in the method of producing the second nanofluid is greater than about 750 mmHg. In some embodiments, the selected pressure used in the method of producing the second nanofluid is greater than about 1,000 mmHg. In some embodiments, the selected pressure used in the method of producing the second nanofluid is greater than about 1,250 mmHg. In some embodiments, the selected pressure used in the method of producing the second nanofluid is greater than about 1,500 mmHg. In some embodiments, the selected pressure used in the method of producing the second nanofluid is greater than about 1,750 mmHg. In some embodiments, the selected pressure used in the method of producing the second nanofluid is greater than about 2,000 mmHg. In some embodiments, the selected pressure used in the method of producing the second nanofluid is greater than about 2,250 mmHg. In some embodiments, the selected pressure used in the method of producing the second nanofluid is greater than about 2,500 mmHg. In some embodiments, the selected pressure used in the method of producing the second nanofluid is greater than about 2,750 mmHg. In some embodiments, the selected pressure used in the method of producing the second nanofluid is greater than about 3,000 mmHg.

In some embodiments, the selected amount of time used in the method of producing the second nanofluid is between about 0.1 hours and 12 hours. In some embodiments, the selected amount of time used in the method of producing the second nanofluid is between about 0.5 hours and 9 hours. In some embodiments, the selected amount of time used in the method of producing the second nanofluid is between about 1.0 hour and 6 hours. In some embodiments, the selected amount of time used in the method of producing the second nanofluid is greater than about 1.0 hour. In some embodiments, the selected amount of time used in the method of producing the second nanofluid is greater than about 2.0 hours. In some embodiments, the selected amount of time used in the method of producing the second nanofluid is greater than about 2.0 hours. In some embodiments, the selected amount of time used in the method of producing the second nanofluid is greater than about 2.0 hours. In some embodiments, the selected amount of time used in the method of producing the second nanofluid is greater than about 3.0 hours. In some embodiments, the selected amount of time used in the method of producing the second nanofluid is greater than about 4.0 hours. In some embodiments, the selected amount of time used in the method of producing the second nanofluid is greater than about 5.0 hours. In some embodiments, the selected amount of time used in the method of producing the second nanofluid is greater than about 6.0 hours. In some embodiments, the selected amount of time used in the method of producing the second nanofluid is greater than about 7.0 hours. In some embodiments, the selected amount of time used in the method of producing the second nanofluid is greater than about 8.0 hours. In some embodiments, the selected amount of time used in the method of producing the second nanofluid is greater than about 9.0 hours. In some embodiments, the selected amount of time used in the method of producing the second nanofluid is greater than about 10.0 hours. In some embodiments, the selected amount of time used in the method of producing the second nanofluid is greater than about 11.0 hours. In some embodiments, the selected amount of time used in the method of producing the second nanofluid is greater than about 12.0 hours. In some embodiments, the selected amount of time used in the method of producing the second nanofluid is greater than about 12.0 hours. In some embodiments, the selected amount of time used in the method of producing the second nanofluid is greater than about 11.0 hours. In some embodiments, the selected amount of time is less than about 10.0 hours. In some embodiments, the selected amount of time used in the method of producing the second nanofluid is less than about 9.0 hours. In some embodiments, the selected amount of time used in the method of producing the second nanofluid is less than about 8.0 hours. In some embodiments, the selected amount of time used in the method of producing the second nanofluid is less than about 7.0 hours. In some embodiments, the selected amount of time used in the method of producing the second nanofluid is less than about 6.0 hours. In some embodiments, the selected amount of time used in the method of producing the second nanofluid is less than about 5.0 hours. In some embodiments, the selected amount of time used in the method of producing the second nanofluid is less than about 4.0 hours. In some embodiments, the selected amount of time used in the method of producing the second nanofluid is less than about 3.0 hours. In some embodiments, the selected amount of time used in the method of producing the second nanofluid is less than about 2.0 hours. In some embodiments, the selected amount of time used in the method of producing the second nanofluid is less than about 1.0 hour.

In some embodiments, the method of producing the second nanofluid comprises separating and rinsing the second nanofluid to have a pH between about 3 and about 10. In some embodiments, the separation steps involve washing the nanofluid with deionized water and repeatedly filtering it until the desired pH is achieved, which can depend on the amount of impurities present. In some embodiments, the method of producing the second nanofluid comprises buffering the second nanofluid to have a pH between about 3.5 and about 9. In some embodiments, the method of producing the second nanofluid comprises buffering the second nanofluid to have a pH between about 4 and about 8.5. In some embodiments, the method of producing the second nanofluid comprises buffering the second nanofluid to have a pH between about 5 and about 8. In some embodiments, the method of producing the second nanofluid comprises buffering the second nanofluid to have a pH greater than about 4. In some embodiments, the method of producing the second nanofluid comprises buffering the second nanofluid to have a pH greater than about 5. In some embodiments, the method of producing the second nanofluid comprises buffering the second nanofluid to have a pH greater than about 6. In some embodiments, the method of producing the second nanofluid comprises buffering the second nanofluid to have a pH greater than about 7. In some embodiments, the method of producing the second nanofluid comprises buffering the second nanofluid to have a pH greater than about 8. In some embodiments, the method of producing the second nanofluid comprises buffering the second nanofluid to have a pH greater than about 9. In some embodiments, the method of producing the second nanofluid comprises buffering the second nanofluid to have a pH greater than about 10. In some embodiments, the method of producing the second nanofluid comprises buffering the second nanofluid to have a pH less than about 10. In some embodiments, the method of producing the second nanofluid comprises buffering the second nanofluid to have a pH less than about 9. In some embodiments, the method of producing the second nanofluid comprises buffering the second nanofluid to have a pH less than about 8. In some embodiments, the method of producing the second nanofluid comprises buffering the second nanofluid to have a pH less than about 7. In some embodiments, the method of producing the second nanofluid comprises buffering the second nanofluid to have a pH less than about 6. In some embodiments, the method of producing the second nanofluid comprises buffering the second nanofluid to have a pH less than about 5. In some embodiments, the method of producing the second nanofluid comprises buffering the second nanofluid to have a pH less than about 4.

In some embodiments, the final concentration of solid content in the second nanofluid ranges from about 0.25 g/L to about 15 g/L. As used herein, the solid content in the second nanofluid comprises the graphite and the graphene. In some embodiments, the solid content in the second nanofluid consists of the graphite and the graphene. In some embodiments, the final concentration of solid content in the second nanofluid ranges from about 0.5 g/L to about 12.5 g/L. In some embodiments, the final concentration of solid content in the second nanofluid ranges from about 1.0 g/L to about 10 g/L. In some embodiments, the final concentration of solid content in the second nanofluid is greater than about 0.5 g/L. In some embodiments, the final concentration of solid content in the second nanofluid is greater than about 1.0 g/L. In some embodiments, the final concentration of solid content in the second nanofluid is greater than about 2.0 g/L. In some embodiments, the final concentration of solid content in the second nanofluid is greater than about 3.0 g/L. In some embodiments, the final concentration of solid content in the second nanofluid is greater than about 4.0 g/L. In some embodiments, the final concentration of solid content in the second nanofluid is greater than about 5.0 g/L. In some embodiments, the final concentration of solid content in the second nanofluid is greater than about 6.0 g/L. In some embodiments, the final concentration of solid content in the second nanofluid is greater than about 7.0 g/L. In some embodiments, the final concentration of solid content in the second nanofluid is greater than about 8.0 g/L. In some embodiments, the final concentration of solid content in the second nanofluid is greater than about 9.0 g/L. In some embodiments, the final concentration of solid content in the second nanofluid is greater than about 10.0 g/L. In some embodiments, the final concentration of solid content in the second nanofluid is greater than about 11.0 g/L. In some embodiments, the final concentration of solid content in the second nanofluid is greater than about 12.0 g/L. In some embodiments, the final concentration of solid content in the second nanofluid is less than about 12.0 g/L. In some embodiments, the final concentration of solid content in the second nanofluid is less than about 11.0 g/L. In some embodiments, the final concentration of solid content in the second nanofluid is less than about 10.0 g/L. In some embodiments, the final concentration of solid content in the second nanofluid is less than about 9.0 g/L. In some embodiments, the final concentration of solid content in the second nanofluid is less than about 8.0 g/L. In some embodiments, the final concentration of solid content in the second nanofluid is less than about 7.0 g/L. In some embodiments, the final concentration of solid content in the second nanofluid is less than about 6.0 g/L. In some embodiments, the final concentration of solid content in the second nanofluid is less than about 5.0 g/L. In some embodiments, the final concentration of solid content in the second nanofluid is less than about 4.0 g/L. In some embodiments, the final concentration of solid content in the second nanofluid is less than about 3.0 g/L. In some embodiments, the final concentration of solid content in the second nanofluid is less than about 2.0 g/L. In some embodiments, the final concentration of solid content in the second nanofluid is less than about 1.0 g/L. In some embodiments, the final concentration of solid content in the second nanofluid is less than about 0.5 g/L.

In some embodiments, the ratio of of graphite to graphene used in producing the second nanofluid is important for, among other things, the thermal performance of the second nanofluid. As such, in some embodiments, the ratio of of graphite to graphene used in producing the second nanofluid is about 10:90 graphite to graphene. In some embodiments, the ratio of of graphite to graphene used in producing the second nanofluid is about 20:80 graphite to graphene. In some embodiments, the ratio of of graphite to graphene used in producing the second nanofluid is about 30:70 graphite to graphene. In some embodiments, the ratio of of graphite to graphene used in producing the second nanofluid is about 40:60 graphite to graphene. In some embodiments, the ratio of of graphite to graphene used in producing the second nanofluid is about 50:50 graphite to graphene. In some embodiments, the ratio of of graphite to graphene used in producing the second nanofluid is about 60:40 graphite to graphene. In some embodiments, the ratio of of graphite to graphene used in producing the second nanofluid is about 70:30 graphite to graphene. In some embodiments, the ratio of of graphite to graphene used in producing the second nanofluid is about 80:20 graphite to graphene. In some embodiments, the ratio of of graphite to graphene used in producing the second nanofluid is about 90:10 graphite to graphene.

In some embodiments, the graphite used in the method of producing the second nanofluid is selected from the group consisting of flake graphite, amorphous graphite, synthetic graphite, electrographite, pyrolytic graphite, polycrystalline graphite, isostatic graphite, vein graphite, expanded graphite and combinations thereof. In some embodiments, the graphite used in the method of producing the first nanofluid is oxidized synthetic graphite.

In some embodiments, the graphene used in the method of producing the second nanofluid is selected from the group consisting of monolayer graphene, multi-layer graphene, bi-layer graphene, exfoliated graphene, CVD graphene, graphene sheets and combinations thereof. In some embodiments, the graphene used in the method of producing the first nanofluid is expanded graphene powder.

In some embodiments, the inorganic acid used in the method of producing the second nanofluid is selected from the group consisting of Phosphoric acid, Sulphuric acid, nitric acid, hydrochloric acid, Boric acid and combinations thereof. In some embodiments, the inorganic acid is nitric acid.

In some embodiments, the organic acid used in the method of producing the second nanofluid is selected from the group consisting of Acetic acid (CH₃COOH), Oxalic acid (C₂H₂O₄), Citric acid (C₆H₈O₇), Lactic acid (C₃H₆O₃), Salicylic acid (C₇H₆O₃), tannic acid, Gallic Acid (C₇H₆O₅) and combinations thereof. In some embodiments, the organic acid is tannic acid.

In some embodiments, the oxidizing agent used in the method of producing the second nanofluid is selected from the group consisting of Potassium permanganate (KMnO₄), Hydrogen peroxide (H₂O₂), Sodium dichromate (Na₂Cr₂O₇), Potassium dichromate (K₂Cr₂O₇), Benzoyl peroxide and combinations thereof. In some embodiments, the oxidizing agent is Hydrogen peroxide.

In one particular embodiment, the ratio of graphite to graphene used in producing the second nanofluid is about 95:5 graphite to graphene, the final concentration of solid content in the second nanofluid is 50 g/L (in water) and has a dilution ratio (base fluid) of 1:10. As would be appreciated by one of ordinary skill in the art, the dilution ratio of 1:10 refers to the process of diluting the concentrated product, which initially contains 50 g/L of solid content in water, with a base fluid (typically water) present in the HVAC system. After the dilution, the total solid content in the final nanofluid is reduced to 5 g/L. In some embodiments, the 5 g/L of solid content is composed of 0.25 g/L of graphene (5% of 5 g/L) and 4.75 g/L of graphite (95% of 5 g/L), maintaining the original 95:5 ratio of graphite to graphene from the concentrated product. In another particular embodiment, the ratio of of graphite to graphene used in producing the second nanofluid is about 95:5 graphite to graphene, the final concentration of solid content in the second nanofluid is 500 g/L (in water) and has a dilution ratio (base fluid) of 1:100. In yet another particular embodiment, the ratio of of graphite to graphene used in producing the second nanofluid is about 80:20 graphite to graphene, the final concentration of solid content in the second nanofluid is 50 g/L (in water) and has a dilution ratio (base fluid) of 1:20.

In some embodiments, the the second nanofluid is free of any dispersants and/or surfactants.

It is noted that the second nanofluid exhibits remarkable improvements in thermal performance, achieving an increase of about 10% to about 20% in convective heat transfer coefficient compared to water. Unlike conventional metal oxide-based nanofluids, the second nanofluid offers several distinct advantages: it eliminates the need for surfactants, ensuring simplicity and long-term stability; it remains stable over a broad pH range, enhancing versatility; and it features intrinsic self-lubricating properties, reducing wear and friction in mechanical systems. Additionally, the second nanofluid demonstrates excellent stability even under static conditions, making it highly suitable for extended use in HVAC applications.

### Example 3—Producing a Third Nanofluid

In some embodiments, a third nanofluid of the present disclosure is a graphite/graphene-based nanofluid for HVAC applications and is prepared by sonicating 10.5 g of expanded graphene powder in 2 L of distilled water for 30 minutes at a power of 70 W. This process ensures a final particle size of D 90 ~55±3 μm. The sonicated mixture is transferred to a hydrothermal reactor, along with 42 g of oxidized synthetic graphite that has pre-treated with inorganic acid 0.06 N and 300 mmol of an organic acid. In some embodiments, the inorganic acid includes one or more of the inorganic acids discussed herein. In some embodiments, the organic acid includes one or more of the organic acids discussed herein. The reactor temperature is set to 80° C.

Then, 105 ml of 30% oxidizing agent is added slowly to the mixture, followed by 15 minutes of stirring. The reaction mixture is heated to 110° C. for 3 hours, maintaining a pressure of approximately 2 bar. Once the reaction is complete, the mixture is cooled to room temperature.

Finally, the content is washed using ultrafiltration until the pH reaches a neutral range of 6-7. After washing, the product is concentrated through nanofiltration and subsequently re-diluted with water to achieve the desired target concentration of solid content, ranging between 1 and 10 g/L.

In some embodiments, the the third nanofluid is free of any dispersants and/or surfactants.

### Example 4—Producing a Fourth Nanofluid

In some embodiments, a fourth nanofluid of the present disclosure is a graphite/graphene-based nanofluid for HVAC applications and is prepared by sonicating 2.5 g of expanded graphene powder in 2 L of distilled water for 30 minutes at a power of 70 W. This process ensures a final particle size of D 90 ~55±3 μm. The sonicated mixture is transferred to a hydrothermal reactor, along with 50g of oxidized synthetic graphite that has pre-treated with inorganic acid 0.06N and 300 mmol of an organic acid. In some embodiments, the inorganic acid includes one or more of the inorganic acids discussed herein. In some embodiments, the organic acid includes one or more of the organic acids discussed herein. The reactor temperature is set to 80° C.

Then, 105ml of a 30% oxidizing agent is added slowly to the mixture, followed by 15 minutes of stirring. The reaction mixture is heated to 110° C. for 3 hours, maintaining a pressure of approximately 2 bar. Once the reaction is complete, the mixture is cooled to room temperature.

Finally, the content is washed using ultrafiltration until the pH reaches a neutral range of 6-7. After washing, the product is concentrated through nanofiltration and subsequently re-diluted with water to achieve the desired target concentration of solid content, ranging between 1 and 10 g/L.

### Example 5—Producing a Fifth Nanofluid

In some embodiments, a fifth nanofluid of the present disclosure is a graphite/graphene-based nanofluid for HVAC applications and is prepared by sonicating 21 g of expanded graphene powder (in 2 L of distilled water for 30 minutes at a power of 70 W. This process ensures a final particle size of D 90 ~55±3 μm. The sonicated mixture is transferred to a hydrothermal reactor, along with 31.5g of oxidized synthetic graphite that has been pre-treated with inorganic acid 0.06N and 300 mmol of an organic acid. In some embodiments, the inorganic acid includes one or more of the inorganic acids discussed herein. In some embodiments, the organic acid includes one or more of the organic acids discussed herein. The reactor temperature is set to 80° C.

Then, 105 ml of a 30% oxidizing agent is added slowly to the mixture, followed by 15 minutes of stirring. The reaction mixture is heated to 110° C. for 3 hours, maintaining a pressure of approximately 2 bar. Once the reaction is complete, the mixture is cooled to room temperature.

Finally, the content is washed using ultrafiltration until the pH reaches a neutral range of 6-7. After washing, the product is concentrated through nanofiltration and subsequently re-diluted with water to achieve the desired target concentration of solid content, ranging between 1 and 10 g/L.

### Example 6—Producing a Sixth Nanofluid

In some embodiments, a sixth nanofluid of the present disclosure is a graphite/graphene-based nanofluid for HVAC applications and is prepared by using graphite, such as, for example, synthetic graphite as a starting material. The graphite is subjected to a milling process that reduces the particle size of the graphite, such as, for example, an average particle size of the graphite to less than 8μm. In some embodiments, this is achieved through high-velocity collisions facilitated by multiple jets of air or steam.

The milled graphite is oxidized by adding the milled graphite and 150 mL of concentrated sulfuric acid to 1.6 L of distilled water and stirring for 10 minutes. In some embodiments, 50 mL of nitric acid is added and stirred for an additional 10 minutes. Next, 100 g of the milled graphite is added to the acid solution and stirred until fully dispersed. The mixture is heated to 60-65° C. and maintained at this temperature for 60 minutes with continuous stirring. In some embodiments, the 60 minutes begins when the fluid reaches the target temperature. After cooling the mixture while continuing to stir, it is washed using centrifugation at 9000 rpm for 3 minutes. This washing process is repeated 3 to 5 times. The washed material is then dried overnight at 60° C. to obtain oxidized milled graphite.

To prepare the sixth nanofluid, 2.5 g of expanded graphene powder is sonicated in 2 L of distilled water for 30 minutes at a power of 70 W. This process ensures a final particle size of D 90 ~55±3 μm. The sonicated mixture is transferred to a hydrothermal reactor, along with 50 g of the oxidized synthetic graphite and 30 mmol of tannic acid. The reactor temperature is set to 80° C. Then, 60 ml of 30% hydrogen peroxide is added slowly to the mixture, followed by 15 minutes of stirring. The reaction mixture is heated to 110° C. for 3 hours, maintaining a pressure of approximately 2 bar. Once the reaction is complete, the mixture is cooled to room temperature. Finally, the content is washed using ultrafiltration until the pH reaches a neutral range of 6-7. After washing, the product is concentrated through nanofiltration and subsequently re-diluted with water to achieve the desired target concentration of solid content, ranging between 1 and 10 g/L. In some embodiments, the target concentration is about 2 g/L. In some embodiments, the target concentration is about 4-5 g/L.

The nanofluids of the present disclosure (e.g., the first nanofluid, the second nanofluid, the third nanofluid, the fourth nanofluid, the fifth nanofluid and/or the sixth nanofluid) have a wide scope of uses including HVAC, power generation, chemical processing and data center cooling. With respect to HVAC, one or more the nanofluids disclosed herein can be applied to various industrial and commercial HVAC systems and related components including chillers, heat exchangers, boilers and energy recovery units. In any hydronic heating and/or cooling system, the nanofluids lower heat exchanger approach temperatures, increasing heat transfer efficiency and reducing energy loss.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A nanofluid, comprising:
a base fluid;
mixed graphite and graphene additive precursors comprising graphite and graphene;
an organic acid; and
an oxidizing agent,
wherein the nanofluid is free of any dispersants and surfactants.

2. The nanofluid recited in claim 1, wherein the mixed graphite and graphene additive precursors have a concentration in the nanofluid between about 1 g/L and about 10 g/L.

3. The nanofluid recited in claim 1, wherein the mixed graphite and graphene additive precursors have a concentration in the nanofluid between about 20 g/L and about 750 g/L.

4. The nanofluid recited in claim 1, wherein the mixed graphite and graphene additive precursors have a concentration in the nanofluid of about 50 g/L.

5. The nanofluid recited in claim 1, wherein the mixed graphite and graphene additive precursors have a concentration in the nanofluid of about 500 g/L.

6. The nanofluid recited in claim 1, wherein the nanofluid has a graphite to graphene ratio of about 20:80.

7. The nanofluid recited in claim 1, wherein the nanofluid has a graphite to graphene ratio of about 10:90.

8. The nanofluid recited in claim 1, wherein the graphite is selected from the group consisting of flake graphite, amorphous graphite, synthetic graphite, electrographite, pyrolytic graphite, polycrystalline graphite, isostatic graphite, vein graphite, expanded graphite and combinations thereof.

9. The nanofluid recited in claim 1, wherein the graphite is oxidized synthetic graphite.

10. The nanofluid recited in claim 1, wherein the graphene is selected from the group consisting of monolayer graphene, multi-layer graphene, bilayer graphene, exfoliated graphene, CVD graphene, graphene sheets and combinations thereof.

11. The nanofluid recited in claim 1, wherein the graphene is expanded graphene powder.

12. The nanofluid recited in claim 1, wherein the organic acid is selected from the group consisting of Acetic acid (CH₃COOH), Oxalic acid (C₂H₂O₄), Citric acid (C₆H₈O₇), Lactic acid (C₃H₆O₃), Salicylic acid (C₇H₆O₃), tannic acid, Gallic Acid (C₇H₆O₅) and combinations thereof.

13. The nanofluid recited in claim 1, wherein the organic acid is tannic acid.

14. The nanofluid recited in claim 1, wherein the oxidizing agent is selected from the group consisting of Potassium permanganate (KMnO4), Hydrogen peroxide (H2O2), Sodium dichromate (Na2Cr2O7), Potassium dichromate (K2Cr2O7), Benzoyl peroxide and combinations thereof.

15. The nanofluid recited in claim 1, wherein the oxidizing agent is hydrogen peroxide.

16. The nanofluid recited in claim 1, wherein the graphite has an average particle size between about 1 μm and 100 μm.

17. The nanofluid recited in claim 1, wherein the graphene has an average particle size between about 1 μm and 100 μm.

18. The nanofluid recited in claim 1, wherein the base fluid is water.

19. A nanofluid, comprising:
a base fluid;
mixed graphite and graphene additive precursors comprising graphite and graphene;
an organic acid; and
an oxidizing agent,
wherein the mixed graphite and graphene additive precursors have a concentration in the nanofluid between about 1 g/L and about 10 g/L,
wherein the nanofluid has a graphite to graphene ratio between about 10:90 and about 90:10,
wherein the base fluid is water,
wherein the graphite is oxidized synthetic graphite,
wherein the graphene is expanded graphene powder,
wherein the organic acid is tannic acid,
wherein the oxidizing agent is hydrogen peroxide,
wherein the graphite has an average particle size less than about 8 μm,
wherein the graphene has an average particle size of about D 90 55±3 μm, and
wherein the nanofluid is free of dispersants and surfactants.

20. A nanofluid, comprising:
a base fluid;
mixed graphite and graphene additive precursors comprising graphite and graphene;
an organic acid; and
an oxidizing agent,
wherein the mixed graphite and graphene additive precursors have a concentration in the nanofluid between about 20 g/L and about 750 g/L,
wherein the nanofluid has a graphite to graphene ratio between about 2:98 and about 30:70,
wherein the base fluid is water,
wherein the graphite is oxidized synthetic graphite,
wherein the graphene is expanded graphene powder,
wherein the organic acid is tannic acid,
wherein the oxidizing agent is hydrogen peroxide,
wherein the graphite has an average particle size less than about 8 μm,
wherein the graphene has an average particle size of about D 90 55±3 μm, and
wherein the nanofluid is free of dispersants and surfactants
